(19) United States
(12) Patent Application Publication
(10) Pub. No.: US 2026/0107222 A1
(43) Pub. Date: Apr. 16, 2026

(54) METHODS IMPLEMENTED BY A COMMUNICATION DEVICE IN A WIRELESS NETWORK AND A CLIENT DEVICE, AND ASSOCIATED DEVICES

(71) Applicant: SAGEMCOM BROADBAND SAS, Bois-Colombes (FR)

(72) Inventor: Massinissa LALAM, Bois-Colombes (FR)

(21) Appl. No.: 19/140,309

(22) PCT Filed: Dec. 19, 2023
(86) PCT No.: PCT/EP2023/086555

§ 371 Date: Jun. 17, 2025

(30) Foreign Application Priority Data
Dec. 21, 2022 (FR) 2214178

(51) Int. Cl. H04W 48/20; H04W 52/02; H04W 88/08

(52) U.S. Cl. CPC H04W 48/20; H04W 52/0238; H04W 88/08

(57) ABSTRACT

A method implemented by a communication device including a plurality of radios, each radio hosting at least one access point for access to a wireless network associated with the access point, an access point having a state from among at least an activated state and a deactivated state comprising the transmission, by a first activated access point of the communication device, of information relating to a second access point even when this second access point is in the deactivated state. Also disclosed is a communication device implementing the method, an associated client device and an associated method.

### TECHNICAL FIELD

Disclosed is a method implemented by a wireless communication device comprising multiple radios, as well as a method implemented by a client device adapted to associate with an access point of one of the radios. The communication device and the client device are also described. One application is the activation and deactivation of access points in a wireless network.

### TECHNICAL BACKGROUND

To meet the growing need for data consumption, more and more frequency bands are being used for wireless transmissions. For example, in the context of the WiFi technology defined by the IEEE 802.11 standard, the first products on the market operated in the 2.4 GHz (11b) band, then 5 GHz (11a) on communication channels 20 MHz wide. Subsequent generations of “WiFi” consolidated the use of these bands by increasing the size of communication channels: 40 MHz with generation 4 (11n/WiFi 4), 160 MHz with generation 5 (11ac/WiFi 5). Generation 6 WiFi (11ax/WiFi 6) additionally introduced the 6 GHz band with 160 MHz wide communication channels, while generation 7 (11be/WiFi 7) extends the channel width in this band to 320 MHz. Today, there is discussion of using the millimeter bands, that is, 60 GHz, for future generation 8 “Wi-Fi”.

With each new generation of WiFi products, more and more radios have to be integrated on the side of an access point within the same hosting apparatus (gateway, router, etc.). In addition to the problems of coexistence among these various radios, the consumption of the whole system becomes a critical point.

By default, all radios are switched on, whether or not any of them have associated client devices or terminals.

A standard approach to reducing the power consumption of a radio is to keep it switched on but in a degraded mode (that is, several transmit/receive channels are switched off) so as to be able to detect connection requests from terminals on said radio. In the event of a positive detection, the device restores the radio to its nominal operating mode. The disadvantage of this approach is that, while it reduces radio consumption, it doesn't completely cut it off. In addition, reducing the number of reception channels can lead to a loss of radio sensitivity, that is, the ability to detect distant terminals.

Another approach is to keep one so-called ‘primary’ radio switched on and one (or more) so-called ‘secondary’ radio(s) switched off in a gateway. A switched-off secondary radio will only be switched back on if a terminal compatible with this secondary radio is detected and associated with the primary radio.

A radio can host one or more access points. Managing radio power consumption therefore requires efficient management of the access points hosted. An efficient solution for managing hosted access points is therefore essential.

### SUMMARY

A first aspect relates to a method implemented by a communication device comprising a plurality of radios, each radio hosting at least one access point for access to a wireless network associated with the access point, an access point having a state from among at least an activated state and a deactivated state, comprising the transmission, by a first activated access point of the communication device, of information relating to a second access point even when this second access point is in the deactivated state.

The dissemination of such information enables a client device to request the activation of an access point that is in the deactivated state, for example, on the basis of the information obtained.

According to one or more embodiments, the information relating to the second access point comprises an identifier of the second access point and the status of the second access point.

According to one or more embodiments, the information relating to the second access point being transmitted in at least one of:
a beacon emitted by the first access point,
a response to an information request from a client device.

It is thus possible to implement either passive discovery of the second access point(s) by a client device simply by receiving a beacon, or active discovery, wherein the client device must issue a request to obtain the information.

In an IEEE 802.11 network, for example, the identifier can be the BSSID.

According to one or more embodiments, the information relating to the second access point being transmitted in a response to an information request from a client device adapted to associate with an access point, transmitted to the first access point, a beacon emitted by the first access point not including information relating to access points other than the first access point.

A client device can therefore only obtain information about the second access point if it is associated with the host device.

According to one or more embodiments, the status of the second access point further comprises a status characterizing a malfunction of the second access point.

A client device can use this information to decide not to send an activation request for a malfunctioning access point.

According to one or more embodiments, an activated access point broadcasts on a transmission channel, the information relating to the second access point comprising, in the case where the second access point is in the deactivated state, the last transmission channel used by the second access point.

According to one or more embodiments, the information relating to the second access point comprises a list of transmission channels on which the second access point is capable of operating.

According to one or more embodiments, said list is included in the information relating to the second access point only in the event that this second access point is in the deactivated state.

According to one or more embodiments, the information relating to the second access point comprises information representative of past statistics of the second access point when it is activated.

According to one or more embodiments, the method comprises receiving, from a client device, a request for activation of the second access point in the deactivated state, the activation request comprising an identifier of the second access point in the deactivated state.

According to one or more embodiments, the activation request comprises at least one reason why the activation request is being made by the client device.

According to one or more embodiments, a reason comprises one of the following:
a type of traffic to be supported,
a type of current traffic whose quality is unsatisfactory on an activated access point;
information representative of the fact that interference due to sources external to the client device exceeds a threshold;
information representative of the fact that interference due to sources internal to the client device exceeds a threshold.

According to one or more embodiments, the method comprises, if the request to activate the second access point is accepted by the communication device,
transmitting a response to the client device that transmitted the activation request, the response comprising information indicating acceptance of the activation request;
activating the second access point for which activation has been requested.

According to one or more embodiments, the method comprises, if the radio hosting the second access point for which activation has been requested is in a deactivated state, activating that radio beforehand.

According to one or more embodiments, the response comprises the transmission of a first timeout defining a minimum duration to be waited before the second access point for which activation has been requested should actually be indicated as activated in the information relating to the second access point.

A client device receiving the first timeout then waits for the indicated time before checking the activation status of the second access point.

According to one or more embodiments, the response includes a minimum duration during which the second access point will be maintained in an activated state by the communication device.

A client device receiving the minimum duration must then associate with the second access point before this duration expires. Beyond that point, the second access point may be deactivated.

According to one or more embodiments, the method comprises the communication device:
monitoring the second access point activated on request;
determining whether no client device is associated with it, and in the event of a positive determination, deactivating the second access point.

According to one or more embodiments, the method comprises, following a positive determination by the communication device, implementing deactivation of the second point if no client device has associated itself with the second access point before a third timeout has elapsed.

According to one or more embodiments, the acceptance of an activation request by the communication device, of an access point being subject to one or more conditions, the method comprises:
once the second access point has been activated, deactivating the second access point if at least one condition is no longer met.

According to one or more embodiments, the method comprises, prior to deactivation, transmission by the communication device of one of the following
a message indicating the next deactivation to client devices associated with the second access point, or
a message containing a request to transition to an activated access point other than the second access point.

According to one or more embodiments, the method comprises transmitting a fourth timeout after which deactivation of the second access point will be performed.

According to one or more embodiments, the method comprises, in the event of the activation request for the second access point being rejected by the communication device, transmitting a response to the client device that transmitted the activation request, the response comprising information indicating that the activation request has been rejected.

According to one or more embodiments, the response comprises a second timeout indicating a minimum time that the client device must wait before repeating its activation request for the second access point.

If an activation request is rejected, a client device will have to wait the specified time before being able to submit a new request.

According to one or more embodiments, the responses comprises a reason behind the rejection decision.

According to one or more embodiments, the response includes information identifying an access point to replace the second access point for which the activation request was rejected.

According to one or more embodiments, the method comprises transmitting an activated or deactivated state of the radio hosting the second access point.

A second aspect relates to a communication device comprising:
a plurality of radios, each radio hosting at least one access point to a wireless network associated with the access point, an access point having one of an activated state and a deactivated state, and
means for carrying out the steps of one of the above methods.

A third aspect relates to a method implemented by a client device adapted to associate by an access point of a communication device in a wireless network, an access point having one of at least an activated state and a deactivated state, the method comprising:
obtaining, from an activated first access point of the communication device, information relating to one or more second access points, even for the second access point(s) whose state is the deactivated state, the information comprising for a given second access point, a respective identifier and the respective state of the given second access point;
if at least one second access point is in a deactivated state, determining whether any of the second access point(s) should be activated, and if so, transmitting a request to the first access point to activate the second access point to be activated.

An activation request may comprise one or more reasons for the request (e.g. the type of traffic the client device requires, etc.). The reason(s) may allow the host device to decide whether or not to activate the access point, or to propose an alternative access point.

According to one or more embodiments, the information relating to a second access point comprises an activation time indication, the indication comprising at least one of:
an activation time for the second access point in the deactivated state; and
an activation time for a radio hosting the second access point in the deactivated state;
determining whether one of the second access point(s) should be activated depending on the indication.

According to one or more embodiments, the information relating to a given second access point identifies a type of traffic supported by this given second access point, the determination of whether one of the second access point(s) should be activated being a function of the type of traffic supported.

According to one or more embodiments, the information relating to a given second access point identifies a type of traffic supported by this given second access point, the determination of whether one of the second access point(s) should be activated being a function of the type of traffic supported.

According to one or more embodiments, the information relating to a given second access point comprises at least one statistic descriptive of a past operation of this given second access point, the determination of whether one of the second access point(s) should be activated being a function of the at least one statistic.

According to one or more embodiments, the method comprises, prior to obtaining information relating to one or more second access points, previously associating with the first access point, transmitting a request for information relating to one or more second access points to the first access point and obtaining this information in response to the request.

According to one or more embodiments, obtaining information relating to one or more second access points comprises receiving a beacon from the first access point, the information relating to one or more second access points being contained in the beacon.

A fourth aspect relates to a client device comprising a communication interface adapted to communicate with an access point in a wireless network; and means for performing the steps of any of the above methods.

One or more embodiments relate to a computer program product comprising instructions which, when the program is executed by a processor of a device, prompt said device to implement one of the described associated methods.

One or more embodiments relate to a storage medium readable by a device provided with a processor, said medium comprising instructions which, when the program is executed by a processor of a device, prompt one of the above devices to implement one of the described associated methods.

### BRIEF DESCRIPTION OF THE FIGURES

Further features and advantages will become apparent from the following detailed description, which may be understood with reference to the attached drawings in which:

FIG. 1 is a functional block diagram of a device according to a particular non-limiting embodiment;

FIG. 2 is a functional block diagram of a radio according to a particular non-limiting embodiment;

FIG. 3 is a diagram showing an example of neighborhood information messages transmitted by activated access points hosted by a device according to a particular, non-limiting embodiment;

FIG. 4 is a message sequence diagram showing the passive discovery of one or more neighbor access points;

FIG. 5 is a message sequence diagram showing the active discovery of one or more neighbor access points;

FIG. 6 is a functional block diagram of a client device according to an exemplary embodiment;

FIG. 7 is a message sequence diagram showing the activation of an access point after acceptance of a client device's request by the host device;

FIG. 8 is a message sequence diagram showing a method for activating an access point by a client device in the context of an ‘MLO’ group according to one exemplary embodiment;

FIG. 9 is a message sequence diagram showing an access point release request according to an exemplary embodiment;

FIG. 10 is a message sequence diagram showing the case of an access point activation request denied by the radio host device for a first reason;

FIG. 11 a message sequence diagram showing the case of an access point activation request denied by the radio host device for a second reason, according to an exemplary embodiment;

FIG. 12 is a message sequence diagram showing the case of an access point activation request, but where the radio hosting the access point whose activation is requested cannot be started, according to an exemplary embodiment;

FIG. 13 is a message sequence diagram showing the deactivation of an access point by a host device 200 according to an embodiment;

FIG. 14 is a message sequence diagram showing the deactivation of an access point by a host device according to a particular exemplary embodiment;

FIG. 15 is a message sequence diagram showing, according to a particular exemplary embodiment, the case of a successful activation request, but where activation of the radio hosting the access point to be activated cannot be carried out.

### DETAILED DESCRIPTION

In the following description, identical, similar or analogous elements will be referred to by the same reference numbers. Unless otherwise indicated, the diagrams are not necessarily to scale.

The block diagrams, flowcharts and message sequence diagrams in the figures shows the architecture, functionalities and operation of systems, apparatuses, methods and computer program products according to one or more exemplary embodiments. Each block of a block diagram or each step of a flowchart may represent a module or a portion of software code comprising instructions for implementing one or more functions. According to certain implementations, the order of the blocks or the steps may be changed, or else the corresponding functions may be implemented in parallel. The method blocks or steps may be implemented using circuits, software or a combination of circuits and software, in a centralized or distributed manner, for all or part of the blocks or steps. The described systems, devices, processes and methods may be modified or subjected to additions and/or deletions while remaining within the scope of the present disclosure. For example, the components of a device or system may be integrated or separated. Likewise, the features disclosed may be implemented using more or fewer components or steps, or even with other components or by means of other steps. Any suitable data-processing system can be used for the implementation. An appropriate data-processing system or device comprises for example a combination of software code and circuits, such as a processor, controller or other circuit suitable for executing the software code. When the software code is executed, the processor or controller prompts the system or apparatus to implement all or part of the functionalities of the blocks and/or steps of the processes or methods according to the exemplary embodiments. The software code can be stored in a memory or a readable medium accessible directly or via another module by the processor or controller.

The exemplary embodiments are non-limiting and are based on networks that comply with the 802.11 family of standards of the Institute of Electrical and Electronics Engineers (IEEE), or so-called “WiFi” networks.

A glossary of the main acronyms used in conjunction with this context is provided at the end of the description.

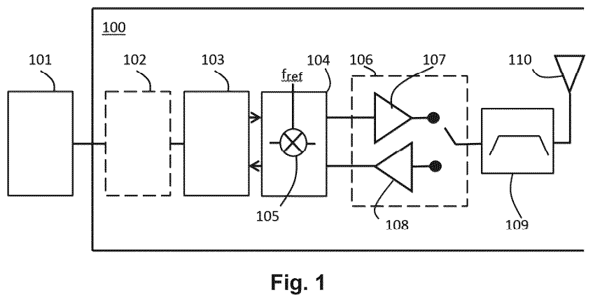

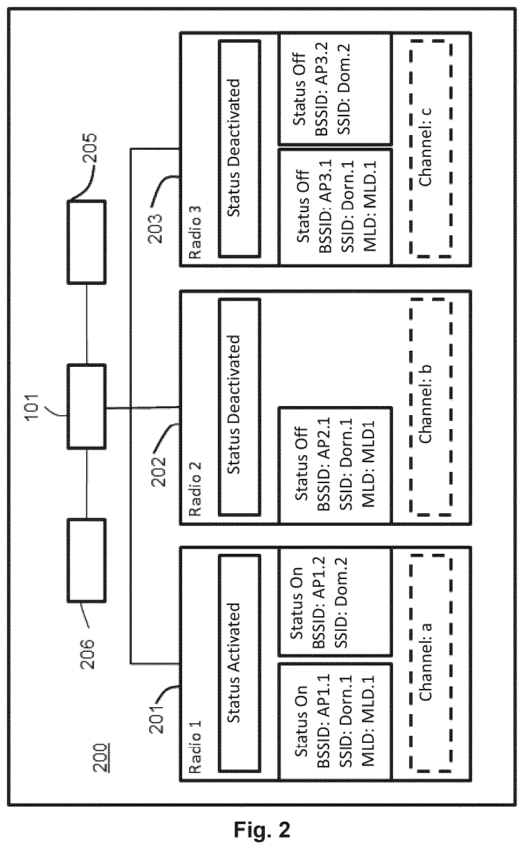

FIG. 1 shows a functional block diagram of a radio 100 according to an illustrative exemplary embodiment, while FIG. 2 is a block diagram of a host device 200 comprising multiple radios.

The radio 100 of FIG. 2 is an example of implementation of one of the radios of FIG. 1. The radio 100 is controlled by means of the microcontroller or processor 101 of the host device 200. The radio comprises a specific processor 102 and digital signal processing processor 103 commonly called “DSP”. The latter comprises a digital/analog converter on the transmission channel and an analog/digital converter on the reception channel. The clean processor 102 of the radio is surrounded by a dotted line to indicate that it may be optional as a separate component depending on the implementation—indeed, according to some embodiments, its functionalities may be integrated with other components, such as the processor 101. The analog signals in transmission, respectively in reception, are modulated, respectively demodulated, by a radiofrequency modem 104 comprising a mixer 105. A front module 106 amplifies the transmission signal (power amplifier 107), while the reception signal is amplified by a low-noise converter block 108. A filter 109 switchable between the transmission channel and the reception channel is interposed between the output of the power amplifier 107 and the antenna 110 on the one hand and the input of the low-noise converter block 108 and the antenna 110 on the other hand. According to the present example, the filter 109 and the antenna 110 are passive components, while the other components are active components. It should be noted that in other implementations, the filter 109 and/or the antenna 110 may also be non-passive components.

FIG. 1 shows the case of a radio with a single transmission/reception chain, however a radio may comprise multiple transmission/reception chains. Some components may be common to multiple chains, for example the processor 102 or the digital signal processing processor 103.

According to certain embodiments, the deactivation of a radio amounts to deactivating the non-passive components of the radio, that is, the power supply thereto is cut off. In the illustrative example of FIG. 1, the non-passive components comprise at least the signal processing processor 103, the modem 104, the front module 105, and if present and separately deactivatable, the clean processor 102. If several reception/transmission chains are present, the non-passive components are deactivated for all chains. The non-passive components may be different in other implementations.

According to other exemplary embodiments, only a subset of said components is deactivated. For example, the power amplifier 107 being a high-consumption component, it is deactivated in priority. However, the processor 102, the digital signal processing processor 103 and the modem 104 are kept activated, that is, powered, to allow a rapid restart of the radio. If the low-noise converter block 108 is kept activated and the switchable element 109 kept set to the reception chain, then the radio still has reception capabilities in order to detect, for example, information request frames.

The device 200 further comprises the processor 101 previously mentioned, a long-term memory 205 and a working memory 206. The processor 101 controls the functionalities of the device 200 and manages the various radios. The memory 205 includes software code that, when executed by the processor, prompts the device to implement one or more described methods. The memory 206 serves notably to store the data relating to the management of the radios, as well as data relating to the associated terminals or terminals likely to be associated with one of the access points. The respective channels on which the three radios work are the channels designated by “a”, “b” and “c”.

According to one or more embodiments, a host device 200 can be a gateway, router, repeater or extender in a wireless mesh network.

According to one or more embodiments, the device 200 comprises at least two radios. Each radio can be independently activated or deactivated. When the host device is in normal operating condition, at least one radio is activated to provide connectivity.

A radio hosts at least one access point (‘AP’), which provides network access to client devices (‘stations’ or ‘STA’) that come to connect.

A network is typically identified by a name. In the case of a “Wi-Fi” network, the name is the identifier “SSID” presented to the user. The AP broadcasting this ‘SSID’ has a unique ‘BSSID’ identifier which has the same format as a MAC address (6 bytes).

A device's capabilities are determined by the standard with which the entities that operate within the wireless network are compatible. In one example, a client device, entity operating within the wireless network, implements functionalities according to the IEEE 802.11 standard described by the amendments 11b/11g/11n/11ax/11be for the 2.4 GHz band, implements functionalities according to the IEEE 802.11 standard described by the amendments 11a/11n/11ac/11ax/11be for the 5 GHz band and implements functionalities according to the IEEE 802.11 standard described by the amendments 11ax/11be in the 6 GHz band, also known as Wi-Fi 6E/7. In this example, amendment 11ax determines the capabilities of the client device and access point. In another example, an access point has functionalities enabling it to operate according to amendments among those of the IEEE 802.11 standard and according to several bands from the 2.4 GHz, 5 GHz and 6 GHz bands. The capabilities of said access point are determined by said amendments and correspond to the functionalities of said access point. By misuse of language, it is possible to speak of standard IEEE 802.11ax or IEEE 802.11ax technology instead of amendment 11ax for example. Encryption protocols, for example WPA2 or WPA3, may also be implemented in exchanges between network entities.

Within an IEEE 802.11 network, access points hosted by different radios can be grouped together. For example, according to the IEEE 802.11be amendment, also known as ‘Wi-Fi 7’, in this ‘MLO’ mode of operation (for ‘multi-link operation’), all grouped access points have a common identifier. In Wi-Fi 7, this common identifier is the MLD MAC Address. All grouped Wi-Fi 7 access points have the same network name (SSID).

According to one or more embodiments, all access points hosted by a radio operate on the same channel, referred to as the radio channel. This channel belongs to a band (e.g., 2.4 GHz, 5 GHz, 6 GHz) which is divided into multiple channels on which the radio can operate. In an IEEE 802.11 network, these channels are generally 20 MHz wide, and can be aggregated to increase the transmission capacity of the so-called operational channel (40 MHz, 80 MHz, 160 MHz or even 320 MHz, depending on the spectrum available in the band).

When a radio is activated, one of the access points it hosts can be activated. An activated access point indicates its presence. In an IEEE 802.11 network, an access point signals its presence by periodically transmitting beacons, or on request by transmitting a probe response frame if a probe request frame has been received. In this state, the radio components required for transmission and reception are powered.

When a radio is deactivated, all the access points it hosts are deactivated.

According to one embodiment, a radio may be activated, but an access point hosted by this radio does not signal its presence. From the outside, this access point is seen as deactivated.

Returning to FIG. 2, the host device 200 comprises three radios 201, 202 and 203. In the example shown in FIG. 2:
an activated radio (Radio 201), hosting:
an activated AP (AP1.1) broadcasting a “Dom.1” network (“Dom” for “Domicile”) belonging to the MLO group identified by “MLD.1”
an activated AP (AP1.2) broadcasting a “Dom.2” network
a deactivated radio (Radio 202), hosting:
a deactivated AP (AP2.1) which, if activated, would broadcast a “Dom.1” network belonging to the MLO group identified by “MLD.1”
a deactivated radio (Radio 203), hosting:
a deactivated AP (AP3.1) which, if activated, would broadcast a “Dom. 1” network belonging to the MLO group identified by “MLD.1”
deactivated AP (AP3.2) which, if activated, would broadcast a “Dom.2” network

An activated access point can signal the presence of other activated neighbor access points. Such information may concern access points on the same radio or another radio as the signaling access point, or access points on a device other than the one hosting the signaling access point's radio. In IEEE 802.11 networks, for example, this neighbor information can be disseminated via a data structure known as an “information element” (IE). This information element can be included in messages transmitted by an activated access point. Examples of such messages are:
beacons issued periodically, including a Reduced Neighbor Report (RNR);
“Probe Response” and “Neighbor Report Response” responses to specific Probe Requests and Neighbor Report Requests, respectively.

The RNR of an access point signaled by another access point generally includes:
the identity (‘BSSID’) of said reported access point,
the network name (‘SSID’) (or its abbreviated version (‘Short SSID’)) of said reported access point,
the frequency band and the width of the operational channels on which said signaled access point operates, this information being provided via a data item known as the “Operating Class”; and
the (primary) channel wherein said access point signals its presence.

Optionally, the RNR can include the MLO group to which the reported access point belongs.

According to one or more embodiments, it is proposed to always indicate the status of a neighbor access point in the neighbor information describing it. More specifically, the data describing a neighbor access point will include information indicating whether said neighbor access point is activated or deactivated.

According to an optional variant, the neighbor information indicates whether the radio hosting a neighbor access point is activated or deactivated.

If a radio is deactivated, then all access points hosted by that radio are deactivated. However, it is possible for a radio to be activated, without all the access points hosted by that radio being activated. A radio can be activated without a hosted access point being activated. The power consumption of such a radio is therefore reduced, but not zero.

Status information can, for example, take on the following three values:
Access point status=ACTIVE or DESACTIVE_MAIS_RADIO_HEBERGEANTE_ACTIVEE or RADIO_HEBERBEANTE_DESACTIVEE

(In English: “BSS Status=UP or DOWN_BUT_HOSTING_RADIO_UP or HOSTING_RADIO_DOWN”)

Depending on the needs of a particular application, this information may be encoded in one bit or more, depending on the level of detail required. For example, if the host radio information does not need to be transmitted, a single bit will suffice to characterize the status of the access point (ACTIVE or DEACTIVE).

The status information can also represent only states other than the activated state. If this information is not present, the default state is activated.

The time taken to switch a radio from a deactivated to an activated state is generally greater than the time taken to switch an access point from a deactivated to an activated state if the radio hosting it is activated. A client device with knowledge of the activation status of both an access point and the radio hosting said access point (e.g. access point deactivated but radio activated) can use this information in a mechanism for selecting which access point to activate according to its needs and their criticality overtime.

Without limiting the generality of the foregoing, only the broadcasting of the activated or deactivated status for a neighbor access point is considered hereafter.

According to one or more embodiments, the neighbor information indicates, when a neighbor access point subject to a neighbor report is currently deactivated, the minimum time required for its activation.

According to one or more embodiments, when a neighbor access point subject to a neighboring report is currently deactivated, the neighboring information indicates the last channel on which this access point was activated.

In IEEE 802.11-type networks, for example, this indication can be coded by identifying the class of operation and a channel number. The class can be encoded in a single byte, and the (primary) channel in a single byte. The list of operating classes for IEEE 802.11 is given in Appendix E of document IEEE802.11-2020 and its subsequent amendments (e.g. IEEE802.11ax-2021).

According to an optional variant, the information about a neighbor access point includes a list of all the channels supported by this access point, in addition to its status. According to another embodiment, this list is included when the state of the neighbor access point is the deactivated state.

In IEEE 802.11 type networks, for example, the above list information may include all the classes of operation supported by the radio hosting the neighbor access point mentioned in the neighbor information. By way of example, this information is encoded by a message including the number of operating classes supported (e.g. one byte) and the identifiers of the operating classes concerned (e.g. one byte per operating class).

According to one or more embodiments, the neighbor information includes conditions for waking up a neighbor access point.

In some implementations, these wake-up conditions are linked to the type of traffic (defined by the quality of service), for example with the support of a certain type of traffic mainly authorized for the moment on this radio (voice, video, etc.).

In IEEE 802.11 type networks, for example, information about the type of traffic associated with wake-up conditions may include one or more of:
one or more authorized Traffic Identifiers (TIDs);
one or more previously negotiated stream identifiers (e.g. a stream classification service such as ‘SCS’, or a mirrored stream classification service such as ‘MSCS’);
one or more flow descriptors not yet negotiated (e.g. a flow descriptor describing the quality of service associated with a flow, such as ‘TSPEC’ (for ‘Traffic SPECification’) describing types of traffic, or ‘TCLAS’ (for ‘Traffic CLASsification’), describing particular flows. These elements can be used to characterize with varying degrees of precision the type of traffic authorized to wake up a currently deactivated access point.

According to an optional embodiment, the neighborhood information comprises information representative of past statistics of the neighbor access point for one or more past periods during which this access point was activated. These statistics may include one or more of the following: average latency, average throughput, average channel occupancy, average jitter, average power consumption at the radio of that particular neighbor access point, etc. For example, this information is averaged over a fixed period of time, such as 10 minutes.

This information can, for example, be encoded by a message indicating the type of statistic, the length of bytes encoding the statistic and the value of this statistic. This is a classic “Type Length Value” (TLV) format.

Table 1 shows the contents of a frame relating to the type of neighbor information for a neighbor access point described in this neighbor information, augmented by the new fields described above. This table is given as a non-limiting example. Neighborhood information may comprise just one of the fields described, or any combination of several of these fields. Fields 1 to 4 in this table are described in the IEEE 802.11 standard.

TABLE 1

| # | Field | Example values/Comments |
|---|---|---|
| 1 | BSSID | |
| 2 | SSID or short SSID | |
| 3 | Operating class | |
| 4 | Primary channel | |
| 5 | BSS status | Activated/Deactivated (“UP”/“DOWN”) |
| 6 | All operating classes | List of operating classes (in the case of an |
| | | IEEE 802.11 network, the possible values of |
| | | an operating class are listed in the tables in |
| | | Appendix E of the standard) |
| 7 | Wake-up conditions | For example, one of: |
| | | (a) Traffic identifier (e.g. TID) |
| | | (b) Traffic descriptor (e.g. TCLAS) |
| | | (c) Flow descriptor (e.g. TSPEC) |
| 8 | BSS - Past statistics | e.g. average latency |
| | | e.g. average throughput |
| | | e.g. average channel occupancy rate |
| | | e.g. average power consumption at neighbor |
| | | access point's radio level |

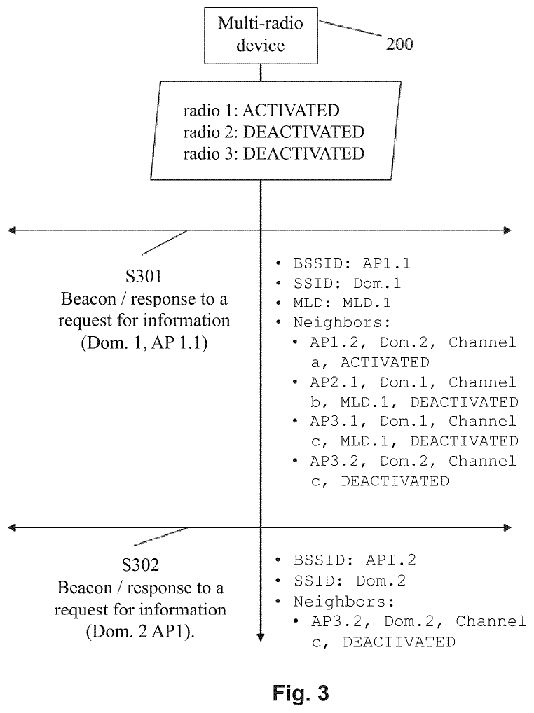

FIG. 3 is a message sequence diagram showing an example of the messages transmitted by active access points of a radio-host device, in the context of the illustrative example of the radios of the device in FIG. 1. The example is set in the context of the host device 200 shown in FIG. 2. Status signaling can be expressed by the activated access points AP1.1 and AP1.2 transmitting information about their neighbors. Access point AP1.1 broadcasts information on all neighbors associated with the Dom.1 and network Dom.2 (message S301), while access point AP1.2 only broadcasts information on the neighbor associated with the same network Dom.2 as itself, that is, access point AP3.2 (message S302).

A client device associating on one of the two activated access points is then aware that one or more other access points are available for the network with which it is associated, as well as their activation status.

As mentioned above, the device can obtain neighborhood information either passively, if the information is broadcast periodically, or actively, by interrogating the directly activated access point. FIG. 3 shows the two possibilities, with messages sent as beacons or as responses to information requests.

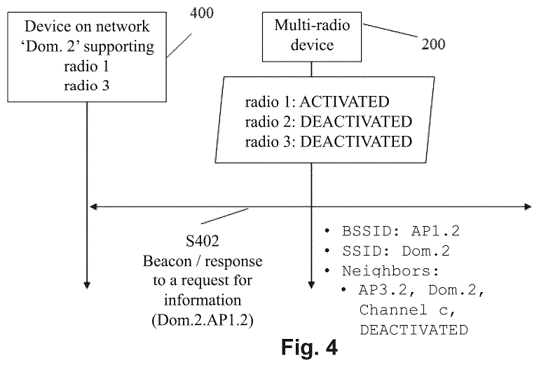

FIG. 4 is a message sequence diagram showing the passive or active discovery of one or more neighbor access points prior to association of a client device when the activated access point publicly broadcasts neighbor information. This figure shows an example of a ‘Dom. 2’ network device supporting radio 1 and radio 3 400, also referred to as client device 400 receiving and decoding beacons (message S402, whose content is similar to that of S302) transmitted by access point AP1.2 including neighborhood information. Alternatively, the client device 400 can receive a probe response including neighborhood information. The client device 400 then learns that another access point AP3.2 is available but switched off.

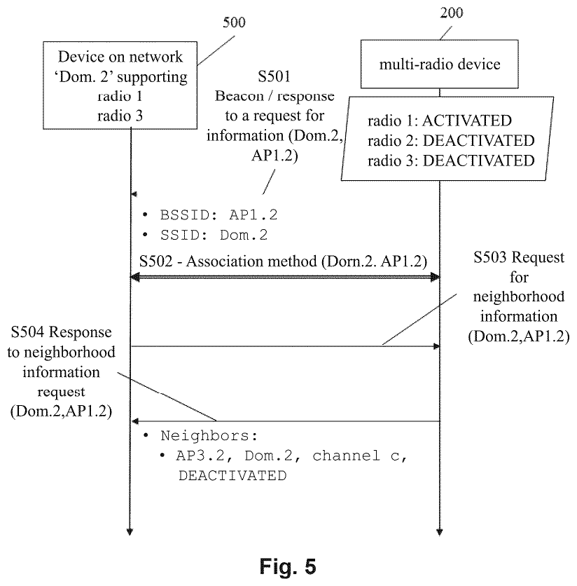

FIG. 5 is a message sequence diagram showing the active discovery of one or more neighbor access points after association of a client device, when the activated access point only broadcasts neighboring information on request from authorized client devices. The ‘Dom. 2’ network device supporting radio 1 and radio 3 500, also known as client 500, associates with the network Dom.2 of access point AP1.2, which is activated on radio 1. The access point AP1.2 broadcasts an S501 beacon (or a response to an information request S501 whose information content is essentially similar to that of the beacon S501), but does not broadcast information about neighbor access points. This is the case, for example, when it's useful to reduce the size of beacons. In FIG. 5, messages explicitly linked to the association are deliberately grouped together in an S502 exchange, as they are known in their own right. At the end of this exchange, the client 500 is authorized to use the network. The terms “associated” and “authorized” will be used interchangeably in the following. The client then actively requests the list of neighbor access points from the access point AP1.2 (Neighborhood information request—message S503), which it receives (Neighborhood information request response S504). The client 500 then learns that another access point AP3.2 is available but deactivated. The advantage of this approach over discovery as described in FIG. 4 is that the discovery of equipment capabilities is only known by authorized clients (that is, those who have successfully completed the association procedure).

According to one or more embodiments, a client device associated with an access point of a first radio may wish to associate with an access point of a second radio. One possible reason is that the frequency band of the second radio is better suited to the needs or constraints of the client device than the frequency band of the first radio. In the examples shown in FIGS. 4 and 5, a client device supporting both radio 1 and radio 3 channels may be interested in radio 3 rather than radio 1 for its traffic—for example, radio 1 operates at 2.4 GHz, while radio 3 operates at 6 GHz.

According to one or more embodiments, a client device must be associated with an activated access point in order to be able to request activation of a deactivated access point. In this way, once associated with an access point, the client device can send on this link a request to activate the other access point(s) currently deactivated and which are adapted to operate on bands and channels supported by said client device. Requiring prior association with an activated access point before requesting activation of a deactivated access point prevents activation requests from coming from unauthorized client devices on the network.

Depending on the various optional elements additionally present in the neighborhood information, a client device can make a more informed decision as to whether or not to request activation of another access point and then associate with it.
According to a first example, the client device checks the quality of service levels authorized by a given deactivated access point considered for activation. If these quality of service levels do not cover the client device's current or future traffic, the client device will not request activation of the given access point.
According to a second example, if the past statistics of a given deactivated access point considered for activation do not seem to suit the current or future traffic type of the client device, the client device will not request activation of the given access point.

According to a particular embodiment, a request to activate a deactivated access point includes an identifier for this access point. For an IEEE 802.11 network, this identifier is, for example, the BSSID.

According to one embodiment, an activation request includes information indicating one or more reasons for requesting activation.

Examples of reasons for activation are:
(a) A type of traffic to be supported: type of quality of service, a pattern, required latency, required throughput (e.g. one or more of TID, TSPEC, TCLAS for an IEEE 802.11 network), required duration.
(b) An unsatisfactory quality for a current type of traffic on the currently activated access point and a negotiated traffic identifier if available (e.g. one or more of a TID, TSPEC, TCLAS or SCSID (if negotiated) for an IEEE 802.11 type network).
(c) An interference level above a threshold. The interference level is measured by the client device on the channel of the current access point (that is, with which it is currently associated), and corresponds to a disruptive signal level. The level of interference may be external (external interference may be due to neighboring networks, for example) or internal (internal interference may be due to other internal radios on the client device).

Table 2 shows a non-limiting example of the content of an activation request frame. Items 3 and 4 are optional. For example, the ‘Reason’ field (table 2, field 3) can be encoded in one byte. Depending on the value of this ‘Reason’ field, an additional field (table 2, field 4) can be added to specify the reason. For example, for an IEEE 802.11 network, in the event of a request for activation by declaration of voice traffic to be supported, the additional field can indicate the TID associated with the voice and optionally the associated parameters (TCLAS).

TABLE 2

| # | Field | Example values/Comments |
|---|---|---|
| 1 | BSSID | |
| 2 | SSID or short SSID | |
| 3 | Reason | For example, one of: |
| | | (a) Traffic identifier to be supported |
| | | (b) Type of traffic with unsatisfactory quality |
| | | (c) External interference on current link |
| | | (d) Internal interference on current link |
| 4 | Additional information | For cases (a) and (b) above: |
| | about the reason | (a) for example, TID, TSPEC or TCLAS |
| | | (b) for example, TID, TSPEC, TCLAS or |
| | | SCSID (if negotiated) |

The host device 200 receiving the activation request from a currently deactivated access point via an activated access point will analyze this request.

The host device 200 will then respond via an activated access point to the client device having made the activation request, either by rejecting the activation request, or by accepting the activation request and then implementing the means to activate the currently deactivated access point. This may include activating the radio hosting the deactivated access point if it was switched off.

According to a variant, if the activation request from a currently deactivated access point is accepted, the activated access point responding to the client device that made said activation request can add a timeout T1 to its positive response. The timeout T1 associated with an access point to be activated indicates to the client device requesting activation of this access point the minimum time this client device must wait before checking whether the access point is activated. Until the timeout T1 associated with an access point to be activated has expired, the client device must not send an activation request for the same access point.

By way of example, the value of this timeout T1 can range from a few microseconds if the radio hosting the access point to be activated is activated but the access point itself deactivated, to a few seconds, or even minutes, if the radio has to be activated from a deactivated state (this may involve, for example, re-powering the hardware, loading software drivers, etc.) and/or if scans are required prior to operation (scanning the so-called ‘DFS’ channels at 5 GHz, for example).

Verification by the client device of the activation of the access point whose activation the client device has requested can be carried out passively if this information is broadcast periodically by the currently activated AP. Verification can also be carried out actively, by re-interrogating the initial activated access point to retrieve its updated neighborhood information. This enables the client to identify the channel where the newly activated access point will be located, the latter which may have changed from the one selected prior to its last deactivation.

According to a variant, if the activation request from a currently deactivated access point is accepted, the activated access point responding to the client device that made said activation request can add a duration D1 to its positive response. The duration D1 associated with an access point to be activated indicates to the client requesting activation of this access point the minimum guaranteed activation duration of said access point. After this period, the host reserves the right to deactivate the access point that has been activated. The value of this duration D1 depends on the needs of a particular implementation: it can be a few minutes, or even tens of minutes, especially if the radio was originally completely deactivated. For example, if it takes thirty seconds to fully reactivate a radio and the access points it hosts, it would be unreasonable for D1 to be of the order of a few seconds. This mechanism allows the host device to control its power consumption. Temporary activation of certain access points can therefore be tolerated, but not necessarily continuous activation.

According to a particular embodiment, if the activation request of a currently deactivated access point is rejected, the activated access point responding to the client device that made said activation request can optionally add a T2 timeout to its negative response. The T2 timeout associated with an access point to be activated indicates to the client device that requested activation of this access point the minimum time to wait before repeating this request for this access point.

By way of example, the value of this timeout can be a few minutes or even a few hours. If longer times are required, it may be a good idea not to include the currently deactivated access point in the neighborhood information at all.

According to a particular embodiment, if the activation request of a currently deactivated access point is rejected, the activated access point responding to the client device that made said activation request can add a reason for this rejection to its negative response. Depending on the nature of the reason and how it is handled by the client device, repeated requests by the client device may be limited or avoided altogether.

The reason given depends on the configuration of the host device. Examples of possible reasons include, but are not limited to:
The host device is not in an acceptable time slot for activation (e.g. the host device is configured in energy-saving mode, for example by the user, and the current time slot is not off-peak).
Activating the requested access point would result in power consumption exceeding a threshold set in the host device when configured in power-saving mode. In one embodiment variant, the identity of another currently deactivated access point of a less energy-intensive radio can be transmitted by the host device to the client device.
The requested traffic may be supported by the current access point or another access point in the same network that is currently active. This assumes that the traffic information is present in the activation request sent by the client device. The identity of another suitable currently activated AP can be provided indicatively or preferentially by the host device to the client device.
The requested traffic would cause power consumption to exceed a threshold defined in the host device when configured in power-saving mode (e.g. by the user) due to the activation of the associated radio. This assumes that the traffic information is present in the activation request sent by the client device.

Table 3 shows an example of an activation response frame.

TABLE 3

| # | Field | Example values/Comments |
|---|---|---|
| 1 | BSSID | |
| 2 | SSID or short SSID | |
| 3 | State | Request status: accepted or denied |
| 4 | Timeout | Request status function: |
| | | (a) Request accepted: waiting time before |
| | | checking whether the access point requested |
| | | has been activated |
| | | (b) Request denied: waiting time before a new |
| | | request for activation of the same access point |
| | | can be made |
| 5 | Duration | In the case of a successful request: |
| | | Minimum time during which the access point |
| | | requested will remain activated |
| 6 | Reason | For example, one of: |
| | | (a) The requested traffic can be supported by |
| | | an already activated alternative access point |
| | | (b) Excluding energy-saving time slot |
| | | (c) Activating the access point would cause |
| | | the power consumption threshold for the |
| | | current time slot to be exceeded |
| 7 | Additional | For cases (a) to (c) above: |
| | information | (a) for example BSSID/SSID/channel |
| | about the reason | corresponding to the alternative access point |
| | | (b) depending on whether the option of |
| | | proposing an alternative access point is |
| | | implemented, e.g. BSSID/SSID/channel |
| | | corresponding to the alternative access point |

The Reason field (table 3, field, etc.), for example, is encoded in a single byte. Depending on the value of this reason, an additional field can be added to specify the reason, as seen previously in connection with Table 2. Fields 4 to 7 are optional.

According to a particular embodiment, a single activation request transmitted by a client device can relate to a plurality of access points. The host device will then respond for each access point, for example by concatenating the responses.

According to a particular embodiment, the host device continuously checks the status of the access points it has activated on demand. If no more client devices are associated with such an access point, the host device decides to deactivate it.

The host device can set a timeout T3, which is triggered when the last client device is disconnected. When this timeout expires, the host device deactivates the access point concerned. T3 is, for example, a few seconds. The timeout T3 is reset as soon as a client device associates with the access point.

According to one embodiment, when a condition required for the activation of a request-activated access point is no longer met, the host device deactivates the access point(s) concerned.

Non-limiting examples are:
(a) One or more client devices are associated with an access point activated on demand, but there is no traffic or the traffic in progress can be conveyed under the same QoS conditions on another activated access point.
(b) The current power consumption of the host device is above a given threshold.
(c) A so-called full range has been entered and a power-saving mode has been engaged.

In such a case of deactivation, the host device will signal the termination of the access point concerned, indicating a time delay T4, after which deactivation will be effective. The time T4 will generally be chosen to be short, as the access point is about to be switched off once the host device has decided to do so.

According to a particular embodiment, a client device that has made a request to activate an access point can at any time make a request to release this access point. One example is when a client device considers that it no longer needs this access point, or that radio conditions have become less attractive on this access point. For example, the client device has moved away from an access point operating on the 6 GHz band. A reason for release can optionally be given.

Table 4 shows an example of an activation release frame according to a particular exemplary embodiment.

TABLE 4

| # | Field | Example values/Comments |
|---|---|---|
| 1 | BSSID | |
| 2 | SSID or short SSID | |
| 3 | Reason | For example: No more traffic required for this |
| | | access point. |

Field #3 is optional.

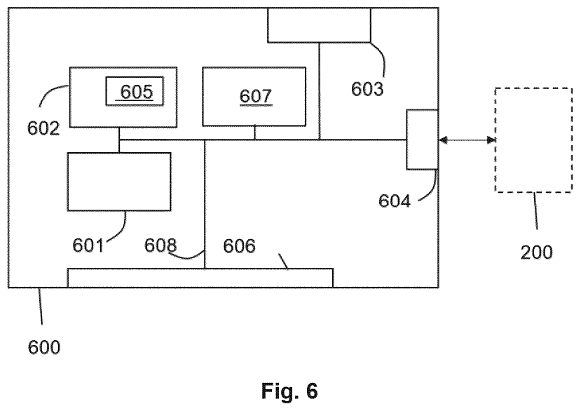

FIG. 6 is a functional block diagram of a client device according to an exemplary embodiment. The client device 600 shown in FIG. 6 is an example of a client device that can be used for implementation according to one of the described embodiments. The client device 600 comprises a processor 601, a memory 602, a user interface 603, a communication interface 604 configured to communicate, for example, with the host device 200, a display 606 suitable for displaying data to a user, as well as a working memory 607.

The various components of the client device 600 are connected via a communication bus 604. The memory 602 comprises software code 605. The memory 607 is used to store and manage the data to be transmitted. When the processor executes the software code 605, it causes the client device 600 to implement a method according to one or more exemplary embodiments described. The client device 600 can be a computer, a cell phone or any other device that can act as a station, terminal or user equipment adapted to interact with the host device 200.

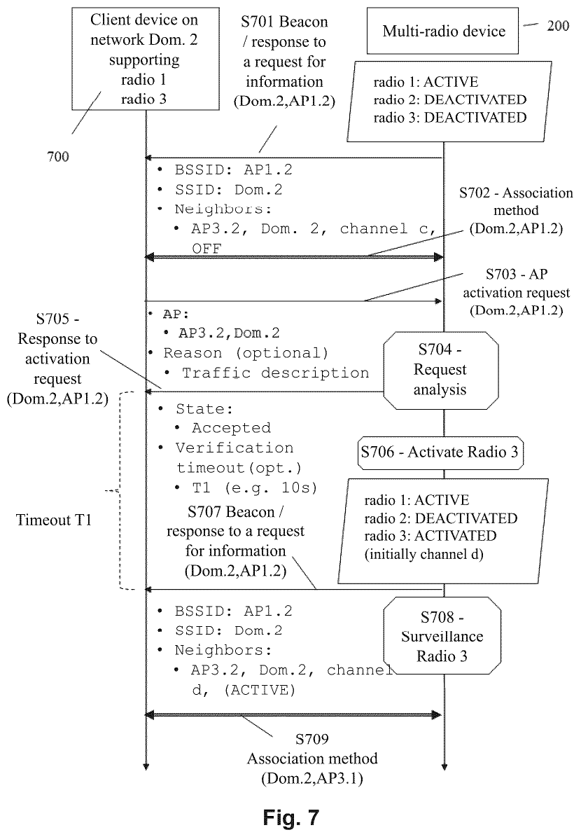

FIGS. 7 to 18 are message sequence diagrams showing the implementation of the data present in the neighborhood information according to one or more exemplary embodiments, both from the point of view of the host device and from that of one or more client devices. These examples are given by way of illustration and placed in the context described in connection with FIG. 2. The data described above can, of course, be used in other contexts too.

FIG. 7 is a message sequence diagram showing a method for activating an access point after acceptance of a client device's request by the host device. The client device 700 supports radios 1 and 3 (that is, it can operate on the respective frequency bands). The client device receives a beacon (S701) from the activated access point AP1.2 on radio 1. This beacon indicates in the neighbor information that an access point AP3.2 exists in a radio 3, but that this access point is deactivated. The client device joins the network Dom.2 of the access point AP1.2 (S702). The client device requests activation of access point AP3.2 (S703), indicating the desired characteristics of the traffic to be carried out with access point AP3.2. The request is analyzed by the host device 200 (S704), which in the case of FIG. 7 responds positively (S705), indicating a timeout T1 to wait before the client device checks whether the access point AP3.1 is operational. The host device 200 then initiates the activation of the radio 3, which was deactivated (S706), whereupon the status of this radio 3 changes from deactivated to activated. The radio selects a new channel, channel ‘d’, different from the channel ‘c’ initially indicated in beacon S701. The client device waits for T1 before checking the activation status of access point AP1.3. After T1 it analyzes the contents of the beacon (S707) of the activated access point AP1.2, which contains neighbor information indicating that the access point AP3.2 is now activated and operating on channel d. The host device monitors radio 2 (S708), for example to see whether or not the client device is associating. In S709, client device 700 associates with access point AP3.1.

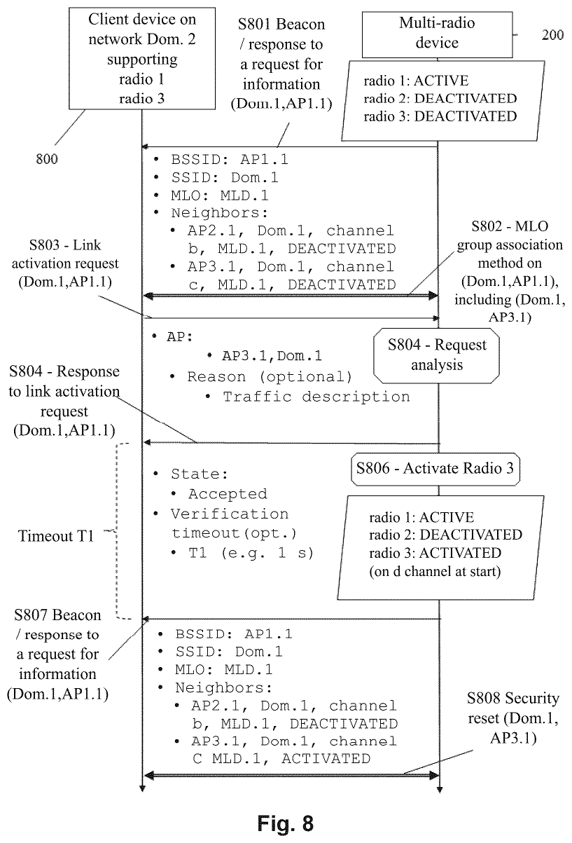

FIG. 8 is a message sequence diagram showing a method for activating an access point by a client device 800 in the context of an ‘MLO’ group according to one exemplary embodiment. It is recalled that all networks in an MLO group have the same standard network identifier (SSID). In this context, association on the various access points of a single MLO group can be carried out on a single access point. The connections between each access point of an MLO group and each station of a client device are called “links”. Access point activation requests in an MLO context then concern links, but the principle remains the same as for activation requests described above.

Returning to the case of FIG. 8, in S801 the client device receives a beacon from the access point AP1.1. The information transmitted in this beacon indicates, among other things, that access point AP1.1 is part of an MLO group designated MLD.1, which also contains access points AP2.1 and AP3.1, both of which are deactivated. A ‘group’ association procedure S802 is then initiated by the client device 800 with the access point AP1.1, including the links associated with the AP1.1 activated access point and the AP 1.3 deactivated access point supported by the client device.

According one embodiment variant, this ‘group’ association procedure S802 contains only the link associated with the activated access point AP1.1.

Once this association is effective, client device 800 sends a link activation request to access point AP1.1 for the link associated with access point AP3.1 (S803). This request (S804) is analyzed by the host device 200, which in the case of FIG. 8 responds favorably (S805) and activates radio 3, hosting access point AP3.1; then consecutively access point AP3.1. The client device waits for a timeout T1 before checking that the link associated with the AP1.3 access point has been activated. A beacon S807 informs the client device 800 that the link associated with AP1.3 is now active. The security parameters are then reset S808.

According to a variant associated with a ‘group’ association that would include all links supported by the client device, even those that are deactivated, this security parameter reset would only concern the point-to-multipoint (multicast) encryption key for the newly activated link, the point-to-point (unicast) key being the same for all access points in the same MLO group.

According to a more general embodiment variant, the security parameters are reset via a ‘group’ reassociation frame, including the links associated with AP1.1 and AP 1.3 supported by the client device.

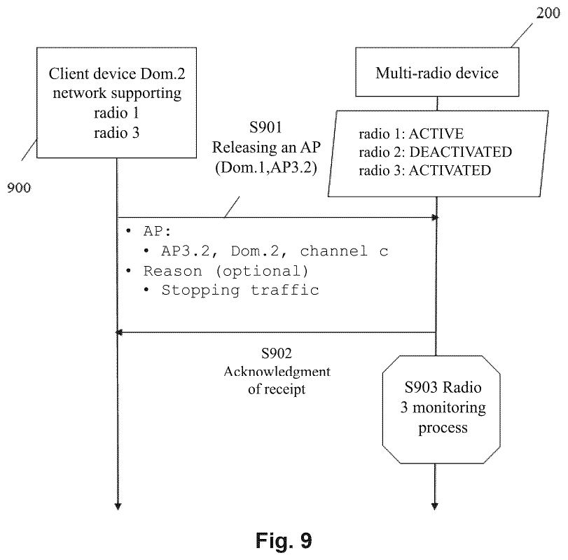

FIG. 9 is a message sequence diagram showing an S901 release request from an access point, for which an activation request has previously been made. The request is acknowledged (in S902) and the access point monitoring process S903 performed by the host device will deactivate this access point if the necessary conditions for this are met, as explained above.

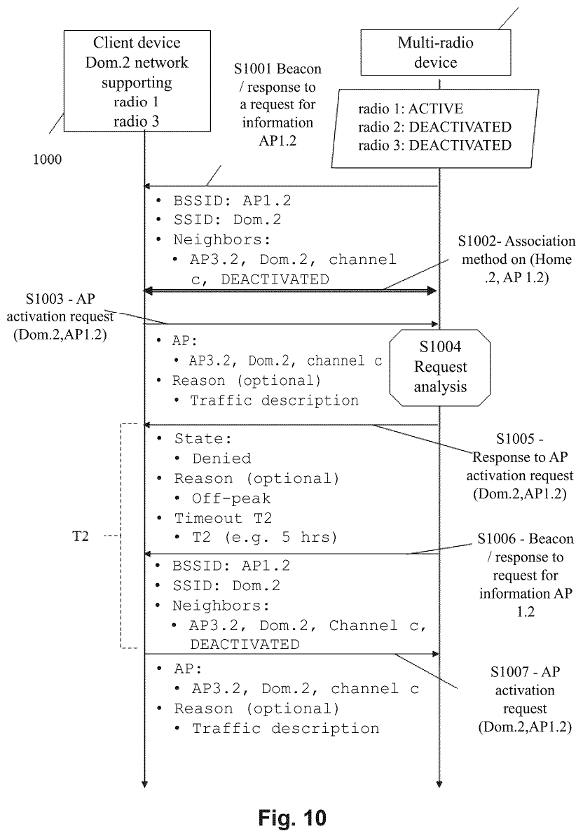

FIG. 10 is a message sequence diagram showing the case where an access point activation request by a client device 1000 is denied by the radios host device 200, in this case because the activation is requested outside off-peak hours while a power-saving mode of the host device is engaged. Steps S1001 to S1004 are similar to steps S701 to S704 in FIG. 7, respectively. In S1005, however, the host device 200 denies the access point activation request, indicates the reason (off-peak period) and gives a timeout T2 before a new activation request for the same access point can be made. A beacon S1006 emitted by the host device confirms that the access point is still deactivated. After T2 has elapsed, client device 1000 makes a new request S1007 to activate access point AP3.2.

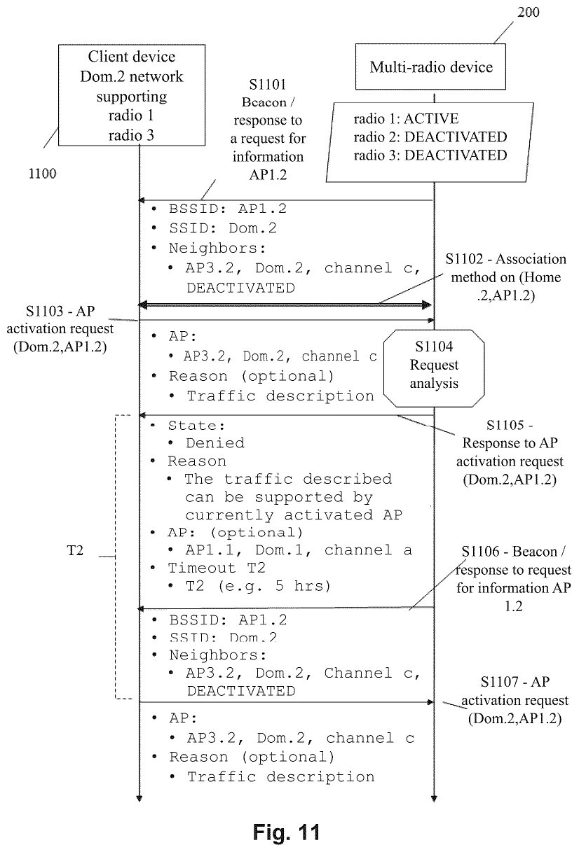

FIG. 11 is a message sequence diagram showing the case where an access point activation request by a client device 1100 is denied by the radio host device 200, in this case because an already active access point can support the traffic described in the activation request. Steps S1101 to S1104 are similar to steps S701 to S704 in FIG. 7 respectively, as the client device seeks to activate the access point AP3.2. In S1105, however, the host device 200 denies the access point activation request, indicates the reason (the traffic described can be supported by a currently activated access point, that is, access point AP1.1, this information being optionally passed in the response to the activation request) and gives a timeout T2 before a new activation request for the same access point can be made by the client device 200. A beacon S1106 emitted by the host device confirms that the access point is still deactivated. After T2 has elapsed, client device 1100 makes a new request S1107 to activate access point AP3.2.

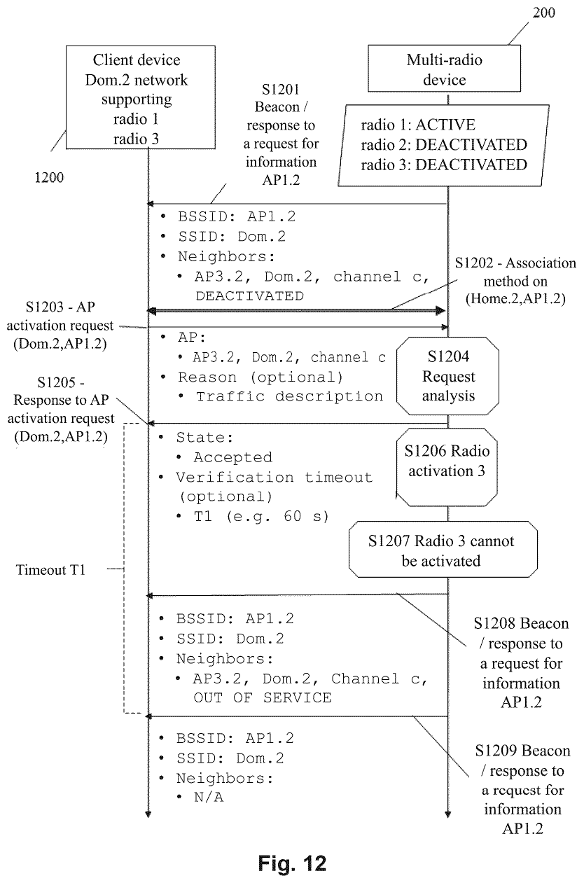

FIG. 12 is a message sequence diagram showing the case, according to a particular exemplary embodiment, of an access point activation request by a client device 1200, which is accepted by a host device 200, but where the radio hosting the access point whose activation is requested cannot be started. Such a case may arise, for example, as a result of a hardware fault or software problem. Steps S1201 to S1204 are similar to steps S701 to S704 in FIG. 7 respectively, as the client device seeks to activate the access point AP3.2. In S1205, the host device 200 accepts the activation request and initiates the activation of radio 3 (S1206). However, this radio cannot be activated (S1207).

According to one embodiment, the host device indicates in the broadcast neighborhood information a malfunction status of the access point whose radio cannot be activated, as shown by S1208. This avoids subsequent activation requests. According to another, non-exclusive embodiment, in the event that a radio cannot be activated, the host device indicates in the broadcast neighborhood information a state of malfunction of all the access points of this radio.

According to a variant shown by S1209, the host device removes from the broadcast neighborhood information the information concerning the access point whose radio cannot be activated.

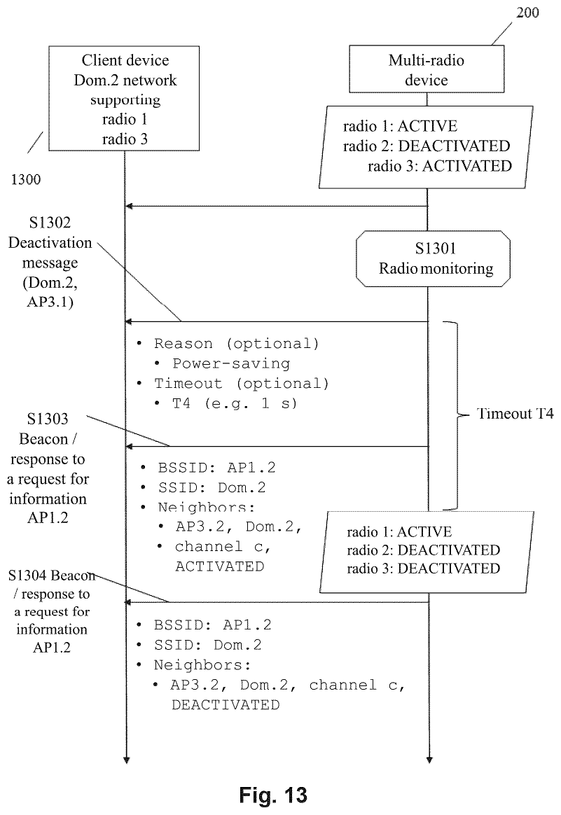

FIG. 13 is a message sequence diagram showing the deactivation of an access point by a host device 200 according to one particular embodiment.

The host device 200 monitors radios (S1301). At some point, the host device decides that the conditions for activating the access point (AP3.2 in the example) are no longer met. An information message (S1302) is broadcast on the network, optionally indicating a reason for the deactivation and optionally the aforementioned timeout T4. This message can be received by the client device 1300. As a reminder, the timeout T4 indicates the minimum time the access point will remain active before being deactivated. A beacon S1303 emitted during the timeout will show the access point still active. The access point is then deactivated. A beacon S1304 transmitted after the timeout will show the access point deactivated. In the example of FIG. 13, the radio 3 is also deactivated. In the example of FIG. 2, it can also deactivate the radio 3, because access point AP3.2 was the only active access point on radio 3.

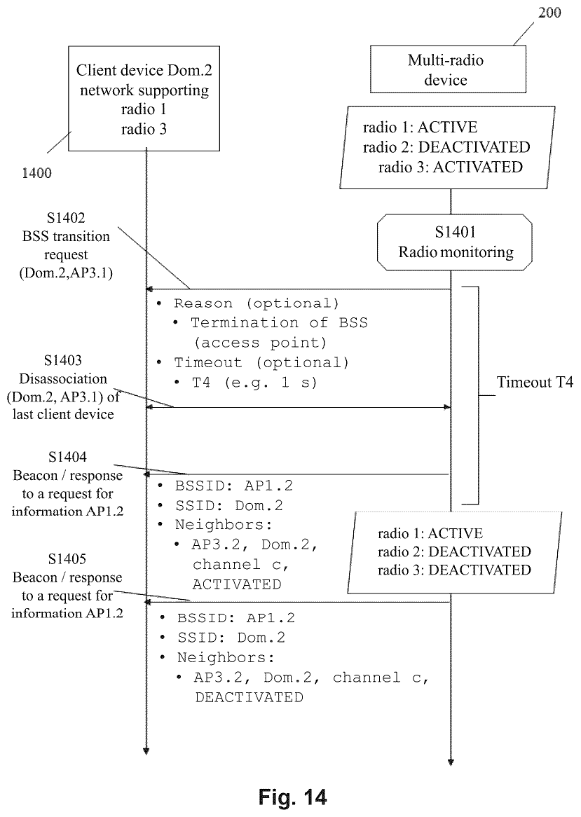

FIG. 14 is a message sequence diagram showing the deactivation of an access point by a host device 200 according to one particular embodiment. In this example, the host device 200 monitors the radio 3. The host device transmits a message (S1402) to a client device 1400 associated with an access point (AP 3.2 in the example). This message requests the 1400 client device (and any other associated client devices) to disassociate from the access point. The reason is optionally given as the access point termination in this case. A timeout T4 is also available as an option. Once the de-association procedure has been completed for the last client device (at S1404), the host device 200 deactivates the access point. A beacon S1404 emitted (for example, by the access point AP1.2, still active) during the timeout period will show the access point still active. The access point is then deactivated. A beacon S1405 transmitted after the timeout will show the access point deactivated. In the example of FIG. 13, the radio 3 is also deactivated. In the example of FIG. 2, it can also deactivate the radio 3, because access point AP3.2 was the only active access point on radio 3. In the context of an IEEE 802.11 network, message 1402 can be an access point transition management message (BTM Request, for “BSS Transition Management Request”).

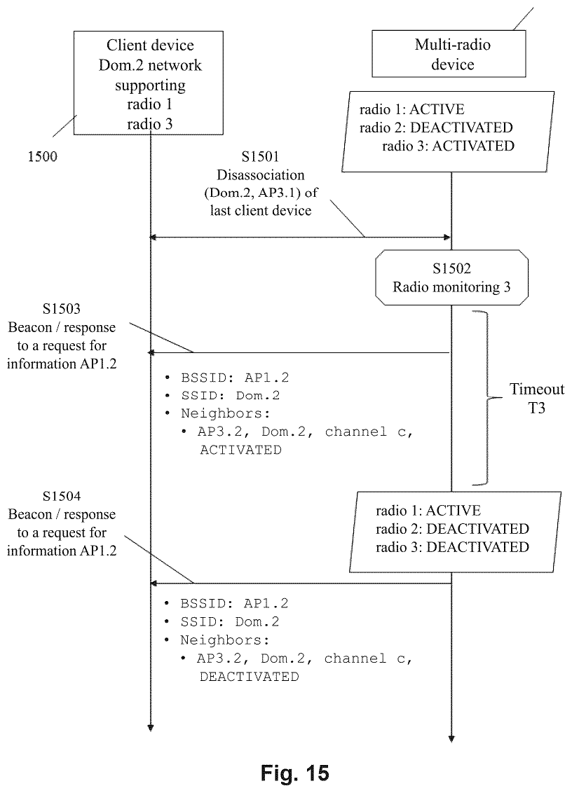

FIG. 15 is a message sequence diagram showing, according to one particular example, the case of deactivation of a demand-activated access point after de-association of the last client device. In S1501, the client device 1500 dissociates from the access point AP3.1. For the purposes of this example, it is assumed that client device 1500 is the last client device present on access point AP3.1. The host device monitors the status of radio 3 and finds that no client device is associated. The host device then waits for a timeout T3 before initiating access point deactivation. A beacon broadcast S1503 (for example by access point AP1.2) during timeout T3 would indicate in its neighbor information which access point is still active. After the timeout T3, the access point is deactivated. A beacon S1504 broadcast at a later date would indicate the deactivated access point.

The principles outlined above can be applied to:
a host device comprising a single radio which itself comprises multiple access points, this host device being able optionally to extend its neighborhood information also to access points of one or more other host devices;
a host device with a single radio which itself has a single access point, but which covers in its neighborhood information one or more access points of other host devices which may have one or more radios.

One or more embodiments thus relate to a method implemented by a communication device comprising a single radio hosting at least one access point for access to a wireless network associated with the access point, an access point having a state from among at least an activated state and a deactivated state comprising the transmission, by a first activated access point of the communication device, of information relating to a second access point even when this second access point is in the deactivated state.

Furthermore, one or more embodiments relate to a method implemented by a communication device comprising a single radio hosting a single access point to a wireless network associated with the access point, the access point having one of at least an activated state and a deactivated state, comprising the transmission, by an activated first access point of the communication device, of information relating to at least one second access point even when this second access point is in the deactivated state, the at least one second access point being hosted by a radio of another host device.

### REFERENCE SIGNS

100—Radio
101—Device processor
102—Radio processor
103—Digital signal processing processor
104—RF modulator/demodulator
105—Mixer
106—Front-end module
107—Power amplifier
108—Low-noise converter block
109—Filter
110—Antenna
200—Host device
201—Radio 1
202—Radio 2
203—Radio 3
205—Long-term memory
206—Working memory
400, 500, 600, 700, 800, 900, 1000, 1100, 1200, 1300, 1400, 1500, 1600, 1700, 1800—Client device
601—Processor
602—Memory
603—User interface
604—Communication bus
605—Software code
606—Display
607—Working memory

### Glossary

TABLE 5

| French | Acronym | English | Function/Comment |
|---|---|---|---|
| Point d'accès | AP | Access Point | Entity managing a |
| | | | wireless local area |
| | | | network (WLAN), that |
| | | | is, broadcasting its |
| | | | presence. In the IEEE |
| | | | 802.11 example, an |
| | | | ‘AP’ contains an ‘STA’. |
| Station | STA | Station | Entity equipped with |
| | | | the means to |
| | | | communicate within a |
| | | | wireless local area |
| | | | network that can |
| | | | connect to a network. |
| Réseau | BSS | Basic Service | Defines a network as |
| | | Set | such. |
| Identifiant de | BSSID | Basic Service | In the IEEE 802.11 |
| base du réseau | | Set IDentifier | example, this identifier |
| | | | has the format of a |
| | | | MAC address, and |
| | | | uniquely identifies the |
| | | | access point enabling |
| | | | connection to the |
| | | | network to which an |
| | | | STA wishes to |
| | | | connect. |
| Identifiant usuel | SSID | Service Set | In the IEEE 802.11 |
| du réseau | | IDentifier | standard example, this |
| | | | identifier has the |
| | | | format of a character |
| | | | string (e.g. ‘Domicile’, |
| | | | meaning ‘home’). It |
| | | | identifies the network |
| | | | for a user. |
| Opération multi- | MLO | Multi-Link | Operating mode for |
| lien | | Operation | grouping multiple |
| | | | physical links, each |
| | | | physical (radio) link |
| | | | being used to |
| | | | broadcast a network to |
| | | | which it is possible to |
| | | | connect. All networks |
| | | | in an MLO group have |
| | | | the same standard |
| | | | network identifier |
| | | | (SSID) |
| Equipement | MLD | Multi-Link | Equipment compatible |
| multi-lien | | Device | with multi-link |
| | | | operation (MLO). |
| Information de | RNR | Reduced | Information broadcast |
| voisinage | | Neighbor | by a PA giving |
| (compressée/ | | Report | indications of the |
| réduite) | | | presence of other |
| | | | neighboring PAs. In |
| | | | the IEEE 802.11 |
| | | | standard example, this |
| | | | includes the BSSID, |
| | | | the SSID or a |
| | | | truncated version of it, |
| | | | the channel on which |
| | | | the AP broadcasts its |
| | | | network. |
| Identifiant de | TID | Traffic | Identifier associated |
| Qualité de | | IDentifier | with a quality of |
| Service (‘QoS’) | | | service, e.g., identifier |
| | | | associated with a type |
| | | | of service (voice, |
| | | | video, best effort, |
| | | | background) |
| Service de | SCS | Stream | Mechanism used to |
| classification de | | Classification | define a quality of |
| flux | | Service | service, and |
| | | | consequently a |
| | | | mapping to a TID, for a |
| | | | given flow. The flow is |
| | | | characterized by |
| | | | addresses, ports, etc., |
| | | | which can be |
| | | | represented by a |
| | | | TCLAS element |
| Service de | MSCS | Mirrored | Mechanism enabling a |
| classification de | | Stream | downstream flow (AP |
| flux réciproque | | Classification | to STA) to be |
| | | Service | associated with the |
| | | | same quality of service |
| | | | as the upstream flow |
| | | | (STA to AP). |
| Descripteur de | TSPEC | Traffic | Describes the quality |
| trafic | | SPECification | of service associated |
| | | | with a flow (expected |
| | | | throughput, latency, |
| | | | etc.) |
| Filtres de trafic | TCLAS | Traffic | Set of masks (e.g. |
| | | CLASsification | address, ports) used to |
| | | | identify a given flow. |
| Qualité de | QoS | Quality of | Defines a service type |
| Service | | Service | |
| Accès protégé | WPA | Wi-Fi | Mechanism for |
| ‘Wi-Fi’ | | Protected | securing a ‘Wi-Fi’ |
| | | Access | wireless network. |
| Contrôle d'accès | MAC | Medium | |
| au support | | Access | |
| | | Control | |
| Element | IE | Information | |
| d'information | | Element | |
| Débit binaire | GBR | Guaranteed Bit | |
| garanti | | Rate | |
| Trame de gestion | BTM | BSS Transition | Frame carrying |
| de point d'accès | | Management | management |
| | | | information for an |
| | | | access point (identified |
| | | | by its BSS) |

1. A method implemented by a communication device comprising a plurality of radios, each radio hosting at least one access point for access to a wireless network associated with the access point, an access point having a state from among at least an activated state and a deactivated state, comprising transmitting, by a first activated access point of the communication device, of information relating to a second access point even when this second access point is in the deactivated state.

2. The method according to claim 1, the information relating to the second access point comprising an identifier of the second access point and a status of the second access point.

3. The method according to claim 1, the information relating to the second access point being transmitted in at least one of:
a beacon emitted by the first activated access point,
a response to an information request from a client device.

4.-5. (canceled)

6. The method according to claim 1, an activated access point broadcasting on a transmission channel, the information relating to the second access point comprising, in a case where the second access point is in the deactivated state, the last transmission channel used by the second access point.

7. The method according to claim 1, the information relating to the second access point comprises a list of transmission channels on which the second access point is capable of operating.

8. The method according to claim 7, said list being included in the information relating to the second access point only in an event that this second access point is in the deactivated state.

9. (canceled)

10. The method according to claim 1, comprising receiving, from a client device, a request for activation of the second access point in the deactivated state, the activation request comprising an identifier of the second access point in the deactivated state.

11. The method according to claim 10, the activation request comprising at least one reason why the activation request is made by the client device.

12. The method according to claim 11, a reason comprising one of:
a type of traffic to be supported;
a type of current traffic whose quality is unsatisfactory on an activated access point;
information representative of the fact that interference due to sources external to the client device exceeds a threshold;
information representative of the fact that interference due to sources internal to the client device exceeds a threshold.

13. The method according to claim 10, comprising, if the request to activate the second access point is accepted by the communication device,
transmitting a response to the client device that transmitted the activation request, the response comprising information indicating acceptance of the activation request;
activating the second access point for which activation has been requested.

14. The method according to claim 13, comprising, if the radio hosting the second access point for which activation has been requested is in a deactivated state, activating that radio beforehand.

15. The method according to claim 13, the response comprising the transmission of a first timeout defining a minimum duration to be waited before the second access point for which activation has been requested should actually be indicated as activated in the information relating to the second access point.

16. (canceled)

17. The method according to claim 13, comprising:
monitoring the second access point activated on request;
determining whether no client device is associated with it, and in an event of a positive determination, deactivating the second access point.

18.-25. (canceled)

26. The method according to claim 1, comprising transmitting an activated or deactivated state of the radio hosting the second access point.

27. A communication device comprising:
a plurality of radios, each radio hosting at least one access point to a wireless network associated with the access point, an access point having one of an activated state and a deactivated state; and
means for carrying out the steps of a method according to claim 1.

28. A method implemented by a client device adapted to associate by an access point of a communication device in a wireless network, an access point having one of at least an activated state and a deactivated state, the method comprising:
obtaining from an activated first access point of the communication device, information relating to one or more second access points, even for the second access point(s) whose state is the deactivated state, the information comprising for a given second access point, a respective identifier and the respective state of the given second access point;
if at least one second access point is in a deactivated state, determining whether any of the second access point(s) should be activated, and if so, transmitting a request to the first access point to activate the second access point to be activated.

29. The method according to claim 28, wherein the information relating to a second access point comprises an activation time indication, the indication comprising at least one of:
an activation time for the second access point in the deactivated state; and
an activation time for a radio hosting the second access point in the deactivated state;
determining whether one of the second access point(s) should be activated depending on the indication.

30.-32. (canceled)

33. The method according to claim 28, comprising, prior to obtaining information relating to one or more second access points, previously associating with the first access point, transmitting a request for information relating to one or more second access points to the first access point and obtaining this information in response to the request.

34. The method according to claim 28, the obtaining of information relating to one or more second access points comprising receiving of a beacon from the first access point, the information relating to one or more second access points being contained in the beacon.

35. A client device comprising
a communication interface adapted to communicate with an access point in a wireless network; and
means for carrying out the steps of a method according to claim 28.
